(19) United States
(12) Patent Application Publication
(10) Pub. No.: US 2012/0199505 A1
(43) Pub. Date: Aug. 9, 2012

(54) KIT WITH WEARABLE DECORATIVE ELEMENTS

(76) Inventors: Kristin BLACK, Ashburn, VA (US); Charles BLACK, Ashburn, VA (US)

(21) Appl. No.: 13/365,943

(22) Filed: Feb. 3, 2012

Related U.S. Application Data
(60) Provisional application No. 61/439,580, filed on Feb. 4, 2011.

(51) Int. Cl. B65D 85/18; D04D 7/10; B23P 11/00; B32B 1/08; A41G 1/00

(52) U.S. Cl. 206/278; 428/34.1; 428/24; 29/428; 428/4

(57) ABSTRACT

Kit of wearable decorative elements. The kit includes at least a main container. At least two securing devices are included. Each securing device is configured to secure at least one wearable decorative element to a user or user's clothing. At least two wearable decorative elements are also included.

### CROSS-REFERENCE TO RELATED APPLICATIONS

The instant application is a US non-provisional Application based on and claims priority to U.S. provisional application No. 61/439,580, filed Feb. 4, 2011, the disclosure of which is hereby expressly incorporated by reference hereto in its entirety.

### BACKGROUND OF THE INVENTION

1. Field of the Invention

This invention relates generally to wearable decorative elements. More specifically, this invention relates to a kit for storing and/or making wearable decorative elements. In embodiments, the wearable decorative elements are worn by children such as on a child's head.

2. Discussion of Background Information

Decorative devices and known as are various ways of attaching decorative elements to securing devices which can in turn be attached to a user's clothing or hair.

Such devices include U.S. Pat. No. 3,192,932 to HART; U.S. Pat. No. 5,573,018 to JOHNSON; U.S. Pat. No. 5,785,065 to JOHNSON; U.S. Pat. No. 2,169,596 to SOLOMON; U.S. Pat. No. 4,991,607 to CHEN; U.S. Pat. No. 5,062,436 to EMSELLEM; US 2004/0237992 to KLUG; US 2009/0266375 to PATREDIS; US 2006/0249172 to BALLEW; and US 2010/0277944 to HURWITZ. The disclosures of each of these documents are expressly incorporated by reference herein in their entireties.

The invention aims to improve devices of the type described above by allowing a user to make their own custom wearable decorative elements and by allowing the user more flexibility in the type, kind, quantity and quality of the wearable decorative elements.

### SUMMARY OF THE INVENTION

According to one non-limiting aspect of the invention there is provided a kit of wearable decorative elements comprising at least a main container, at least two securing devices, each securing device being configured to secure at least one wearable decorative element to a user or user's clothing, and at least two wearable decorative elements.

In embodiments, the at least one main container may comprise a removable cover or lid.

In embodiments, the at least one main container may comprise a paper box with a removable cover or lid.

In embodiments, the kit may further comprise at least one smaller container sized to fit within the main container. The at least one smaller container may comprise a paper box with a removable cover or lid.

In embodiments, at least one of the at least two securing devices may be a hair clip.

In embodiments, at least one of the at least two securing devices may be a hair tie. In embodiments, the hair tie is at least one of flexible and elastically expandable.

In embodiments, at least one of the at least two securing devices may be a U-shaped head or hair band. In embodiments, the U-shaped head or hair band is at least one of flexible and elastically expandable.

In embodiments, at least one of the at least two wearable decorative elements may be at least one of a bow, a hair bow, a section of an artificial flower, an artificial flower, a button, and a bottle cap.

In embodiments, at least one of the at least two wearable decorative elements may be at least one of non-removably attached to one of the at least two wearable decorative elements and non-removably attached to at least one of the at least two securing devices.

In embodiments, at least one of the at least two wearable decorative elements may be at least one of removably attached to one of the at least two wearable decorative elements and removably attached to at least one of the at least two securing devices.

In embodiments, at least one of the at least two wearable decorative elements comprises a releasable attachment mechanism. In embodiments, the releasable attachment mechanism comprises a snap.

According to one non-limiting aspect of the invention there is provided a kit for making and/or storing wearable decorative elements comprising at least a main container, at least two securing devices, each securing device being configured to secure at least one wearable decorative element to a user or user's clothing, and at least two wearable decorative elements. Each of the at least two wearable decorative elements comprises a releasable attachment mechanism.

In embodiments, at least one of the at least two wearable decorative elements may comprise a releasable attachment mechanism. In embodiments, the releasable attachment mechanism may comprise a snap.

According to one non-limiting aspect of the invention there is provided a method of making at least one wearable decorative element utilizing a kit comprising at least a main container, at least two securing devices, each securing device being configured to secure at least one wearable decorative element to a user or user's clothing; and at least two wearable decorative elements. The method comprises at least one of attaching at least one decorative element to at least one securing device, mounting at least one decorative element to at least one securing device, removably securing at least one decorative element to at least one securing device, and securing at least one decorative element to at least one securing device using a snap. The method also includes securing the at least one securing device to a user or a user's clothing

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows a top view of a main container of the kit with the cover removed so that the three smaller containers disposed therein are visible in accordance with the invention;

FIG. 2 shows a top view of the main container of FIG. 1 after the three smaller containers are removed;

FIG. 3 shows a top view of the main container of FIG. 1 after the covers of the three smaller containers disposed therein are removed;

FIG. 4 shows a side cross-section view of one of the smaller containers and illustrates how a stacking and retaining devise can be placed. Three wearable decorative elements are shown stored on the stacking and retaining devise;

FIG. 5 shows a top view of an exemplary stacking and retaining devise with wearable decorative elements stored thereon;

FIG. 6 shows a side view of the stacking and retaining devise of FIG. 5 with the wearable decorative elements removed thereon;

FIG. 7 shows a side cross-section view of a cover for one of the smaller containers and illustrates how it can include a cover attachment system for securing or storing a plurality of clips;

FIG. 8 shows the cover shown in FIG. 7 arranged over the box shown in FIG. 4;

FIG. 9 shows a partial bottom view of the cover shown in FIG. 8, but with the strap retaining thereon two different clips;

FIG. 10 shows an exemplary embodiment of an attachable decorative element wherein three decorative elements are shown in cross-section before being attached to a snap arranged on a securing device. A decorative button having a snap is shown for securing the three decorative elements to the snap of the securing device;

FIG. 11 shows an exemplary embodiment of an attachable decorative element wherein one decorative element is shown in cross-section before being attached to a snap arranged on a securing device. A decorative bow having a snap is shown for securing the decorative element to the snap of the securing device;

FIGS. 12 and 13 shows an exemplary embodiment of an attachable decorative element wherein a decorative element is shown in FIG. 12 before being attached to a snap arranged on a hair clip type securing device. A decorative button having a snap is shown as are additional snaps for securing the decorative element to the snap of the clip;

FIG. 14 shows an exemplary embodiment of an attachable decorative element wherein a decorative element is shown before being attached to a snap arranged on a U-shaped head or hair band securing device. A decorative button having a snap is shown as are additional snaps for securing the decorative element to the snap of the head band;

FIG. 15 shows an exemplary embodiment of an attachable decorative element wherein a decorative element is shown before being attached to a snap arranged on a hat securing device. A decorative button having a snap is shown as are additional snaps for securing the decorative element to the snap of the hat;

FIG. 16 shows an exemplary embodiment of an attachable decorative element wherein a decorative element is shown before being attached to a snap arranged on a hair tie securing device. A decorative button having a snap is shown as are additional snaps for securing the decorative element to the snap of the hair tie; and

FIG. 17 shows an exemplary embodiment of an attachable decorative element wherein a decorative element is shown before being attached to a snap arranged on a hair band securing device. A decorative button having a snap is shown as are additional snaps for securing the decorative element to the snap of the hair band.

### DETAILED DESCRIPTION OF THE INVENTION

In the devices shown in the drawings, various embodiments are provided of a kit with wearable decorative elements.

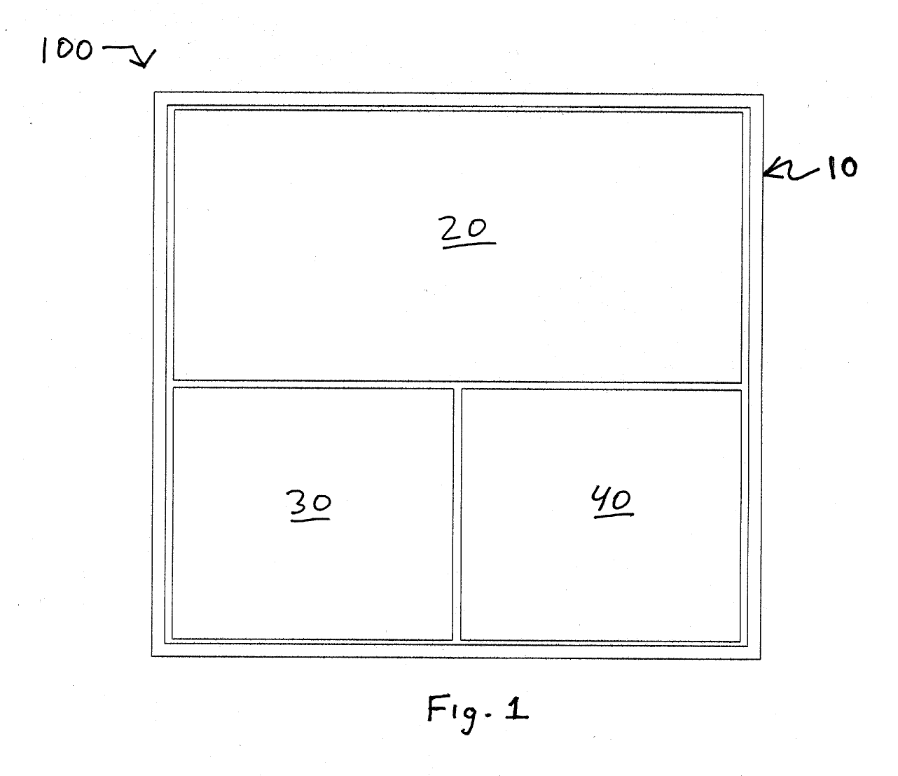

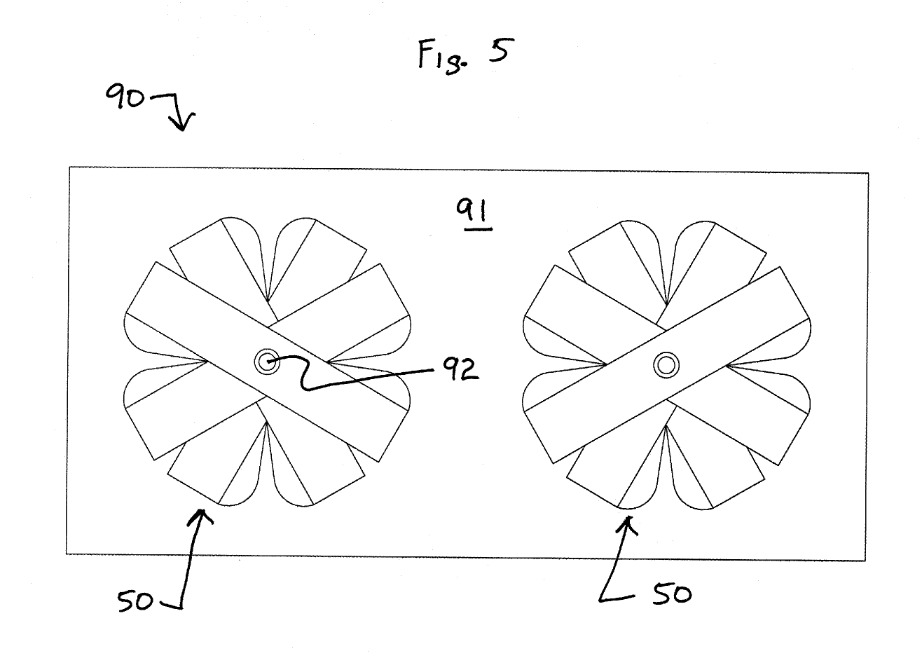

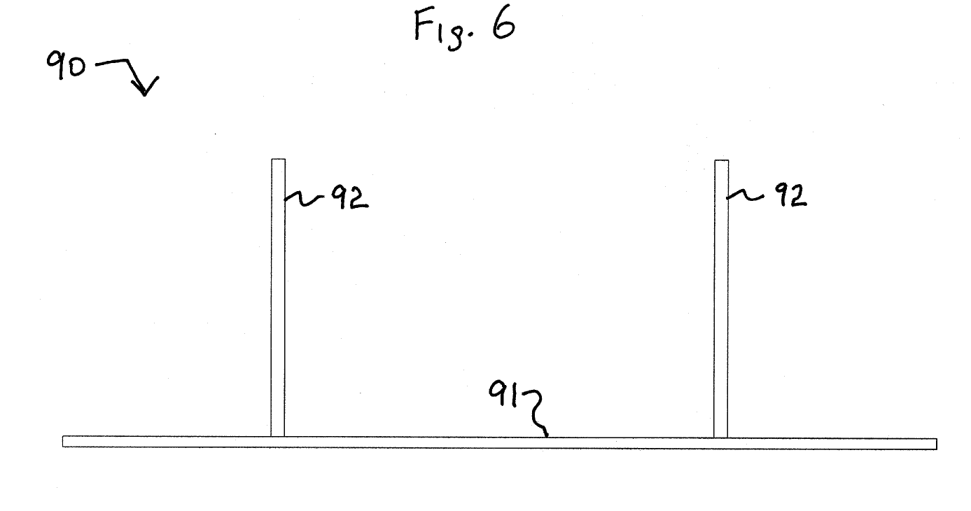

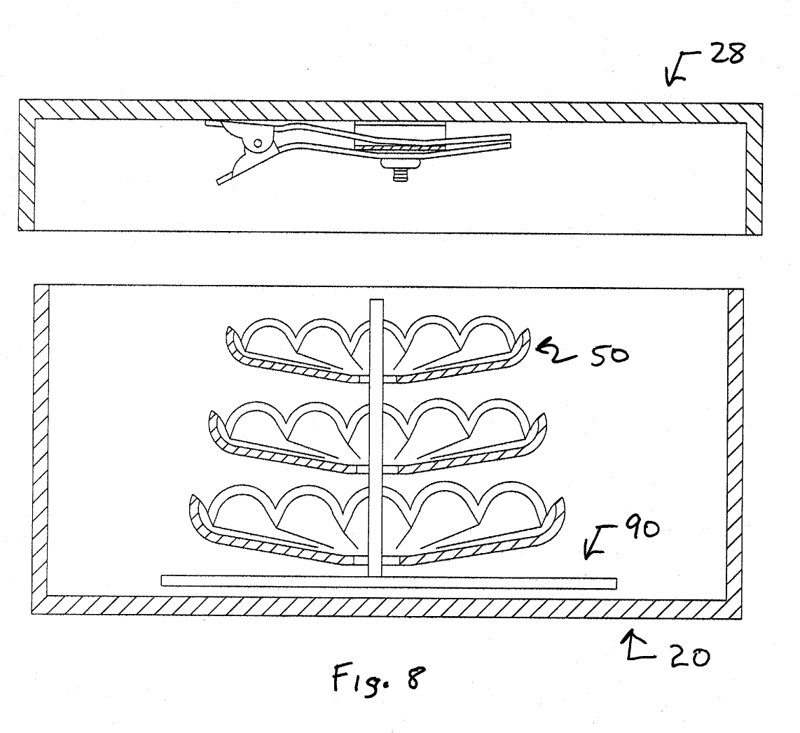

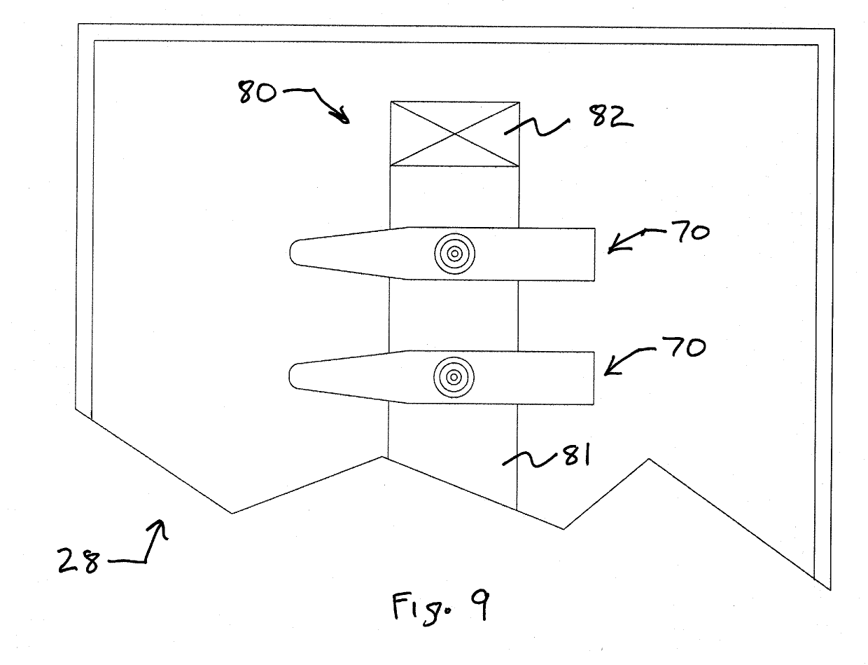

FIGS. 1-9 show one embodiment of the kit 100. The kit 100 includes a main container or box 10 which can be made of, e.g., paper or cardboard, and which can have plain color outer surface or, in embodiments, a decorative outer surface, e.g., any pattern from wallpaper or wrapping paper. Preferably, the outer layer of the box 10 or box cover (not shown in FIGS. 1-6) can provide an indication or foreshadowing of the decorative elements contained in the box 10. As shown in FIG. 1, the main box 10 includes other smaller boxes, e.g., three boxes 20, 30 and 40.

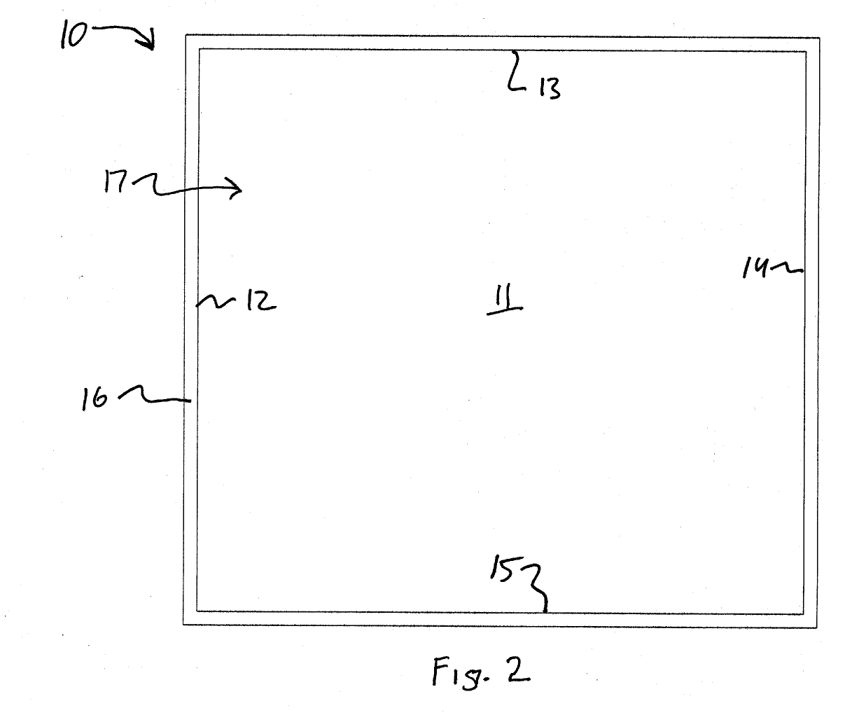

With reference to FIG. 2, it can be seen that the main container or box 10 has a bottom wall 11, generally vertical side walls 12-15 arranged generally perpendicular to the bottom wall 11, a generally rectangular or square upper edge 16 and defines an inner space 17 sized to receive, contain, or store the smaller boxes 20, 30 and 40.

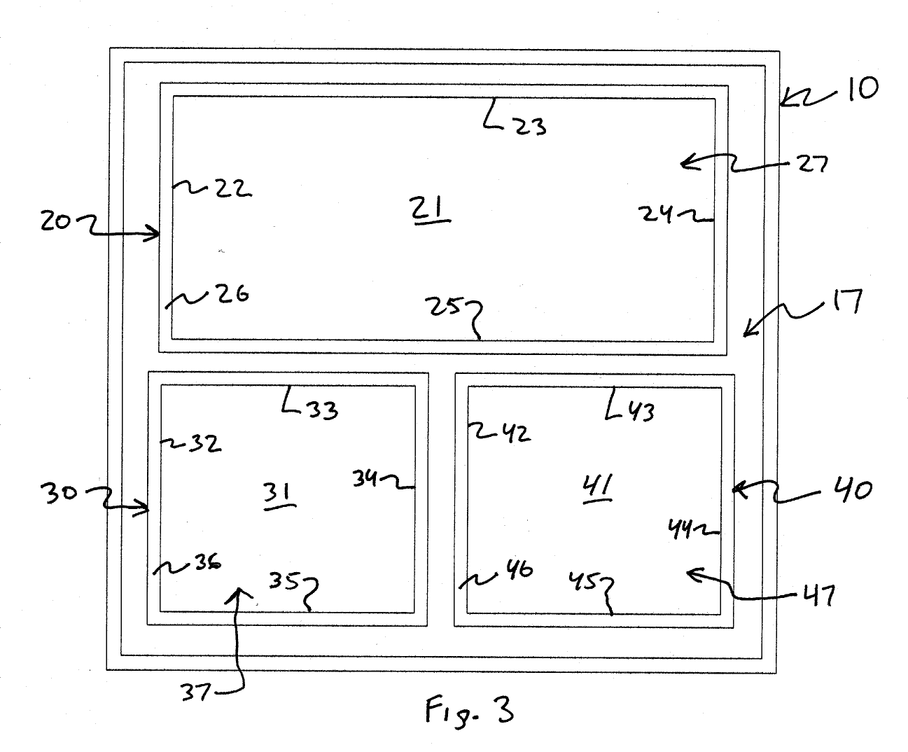

With reference to FIG. 3, it can be seen that the three smaller boxes 20, 30 and 40 have a similar configuration with their covers removed. The larger 20 of the smaller boxes has a bottom wall 21, generally vertical side walls 22-25 arranged generally perpendicular to the bottom wall 21, a generally rectangular upper edge 26 and defines an inner space 27 sized to receive, contain, or store decorative elements—as will be described later on.

Again referring to FIG. 3, it can be seen that the two similar smaller boxes 30 and 40 have a similar configuration with their covers removed. The box 30 of the smaller boxes has a bottom wall 31, generally vertical side walls 32-35 arranged generally perpendicular to the bottom wall 31, a generally rectangular or square upper edge 36 and defines an inner space 37 sized to receive, contain, or store decorative elements—as will be described later on. The box 40 of the smaller boxes also has a bottom wall 41, generally vertical side walls 42-45 arranged generally perpendicular to the bottom wall 41, a generally rectangular or square upper edge 46 and defines an inner space 47 sized to receive, contain, or store decorative elements—as will be described later on.

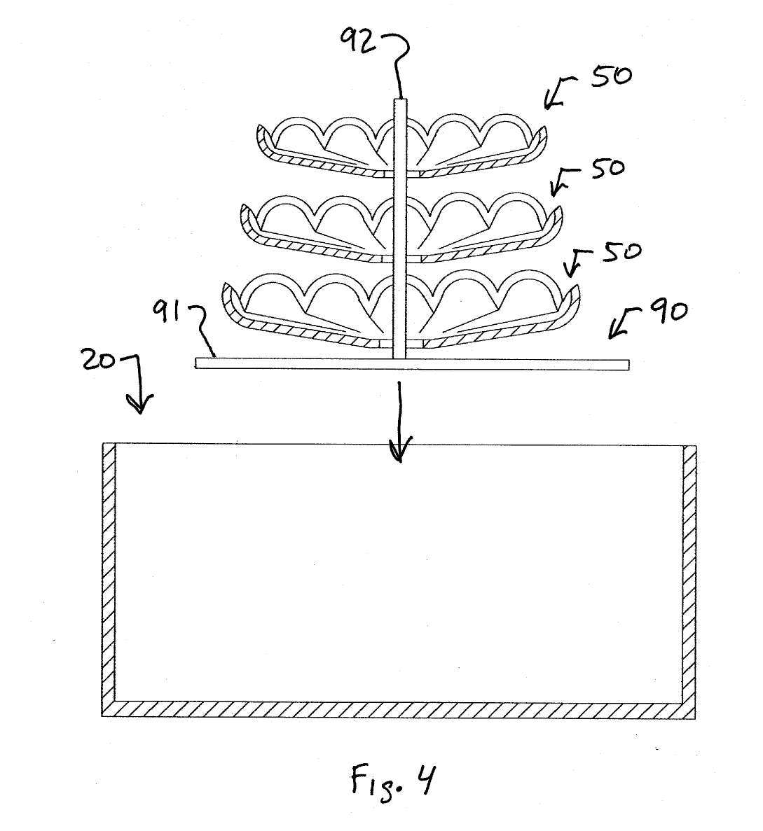

With reference to FIGS. 4-6, it can be seen that the larger small box 20 can receive therein and store a decorative element stacking and retaining device 90 which includes a base 91 and pins 92. A plurality of decorative elements 50 can be slid over and onto each pin 9 and can be slid off as desired. The decorative elements can be of any variety. In embodiments, it can take the form of a flexible section of an artificial flower.

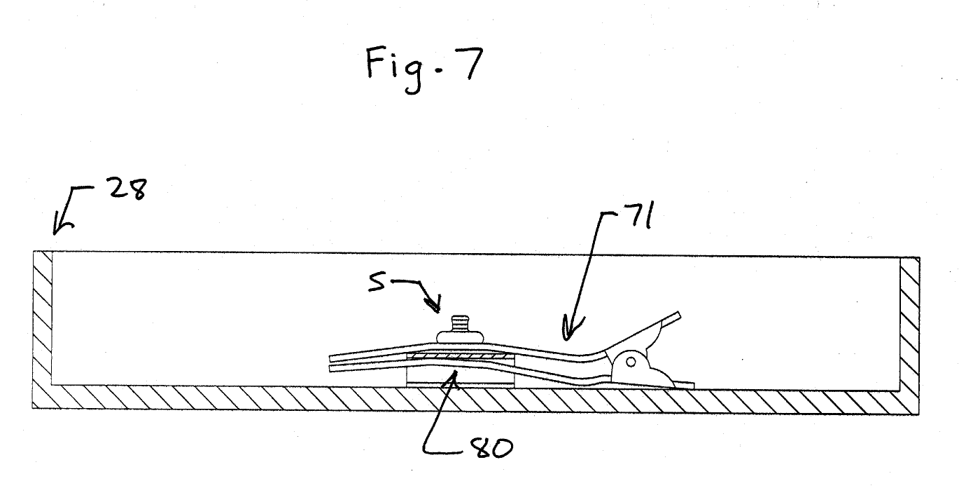

With reference to FIGS. 7-9, it can be seen that the larger small box 20 can be provided with cover 28 whose underside includes clips 70, e.g., one or more hair clips 71, clipped onto to a cover attachment system 80 made up of a strap 81, e.g., an elastic strap, and end attachment sections 82, e.g., end sections adhesively attached to the cover 28. The cover 28 closes off the box 20 and together with the box 20 can store therein plural clips 70 and plural decorative elements 50.

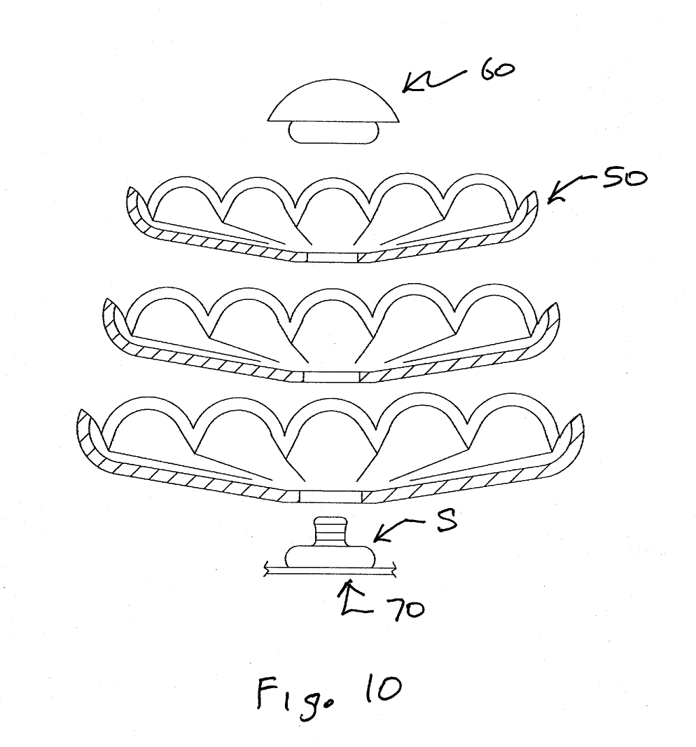

With reference to FIG. 10, it can be seen one exemplary way in which a decorative assembly can be created by a user. In this embodiment, a clip 70 is removed from the cover 28. Then, the user begins placing one or more decorative elements 50 into alignment with and over the projection of the snap S (which can be of any conventional type). The decorative elements are retained on the snap S when the decorative element 60 (having a female receiving portion of the snap S) and being stored in one of the other boxes 30 and 40, e.g., box 30, is snapped-onto the snap S. The decorative element 60 has a button shaped decorative portion (e.g., resembling a center area of daisy) and can be made of e.g., plastic or synthetic resin. The flexible decorative elements 50 are thus axially retained and slightly compressed between the snap S and the decorative snap 60. As should be apparent, the user has numerous options to make a nearly unlimited variety of the decorative assemblies.

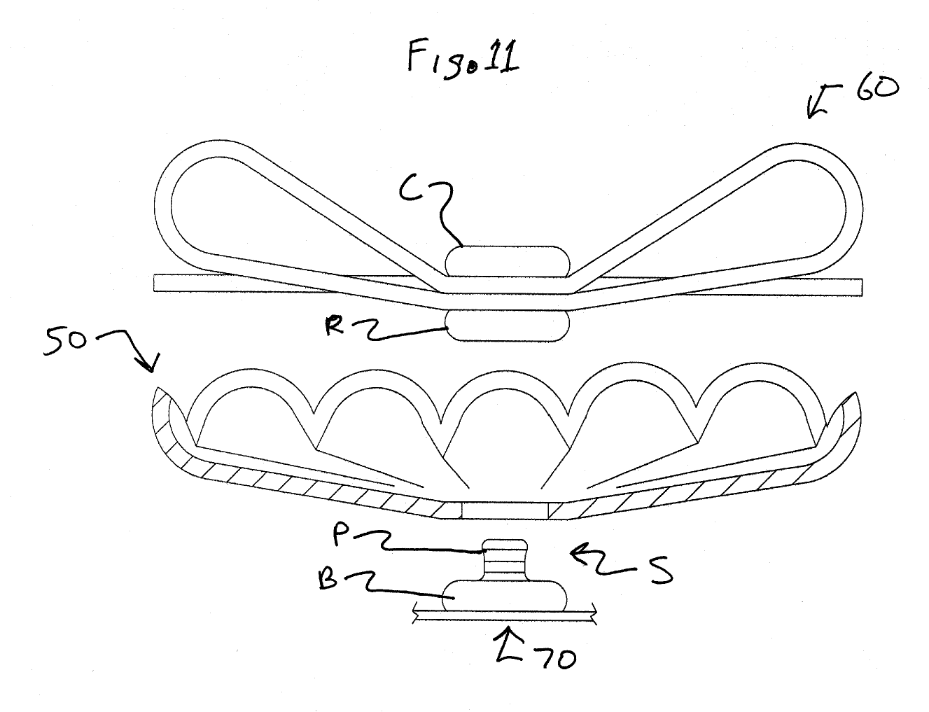

With reference to FIG. 11, it can be seen another exemplary way in which a decorative assembly can be created by a user. In this embodiment, a clip 70 is removed from the cover 28. Then, the user begins placing one or more decorative elements 50 into alignment with and over the projection of the snap S. The decorative elements are retained on the snap S when the decorative element 60′ (having a female receiving portion R of the snap) and being stored in one of the other boxes 30 and 40, i.e., box 40 is snapped-onto the snap S. Like the previous embodiment, the snap S has an insertable snap projection P and a base portion B which is affixed (e.g., via adhesive) to the clip 70. The flexible decorative element 50 is thus axially retained and slightly compressed between the snap S and the decorative snap 60′. However, unlike the previous embodiment, the decorative element 60′ also includes a flexible flower portion as well as a decorative button portion C. As should be apparent, the user has numerous options to make a nearly unlimited variety of the decorative assemblies.

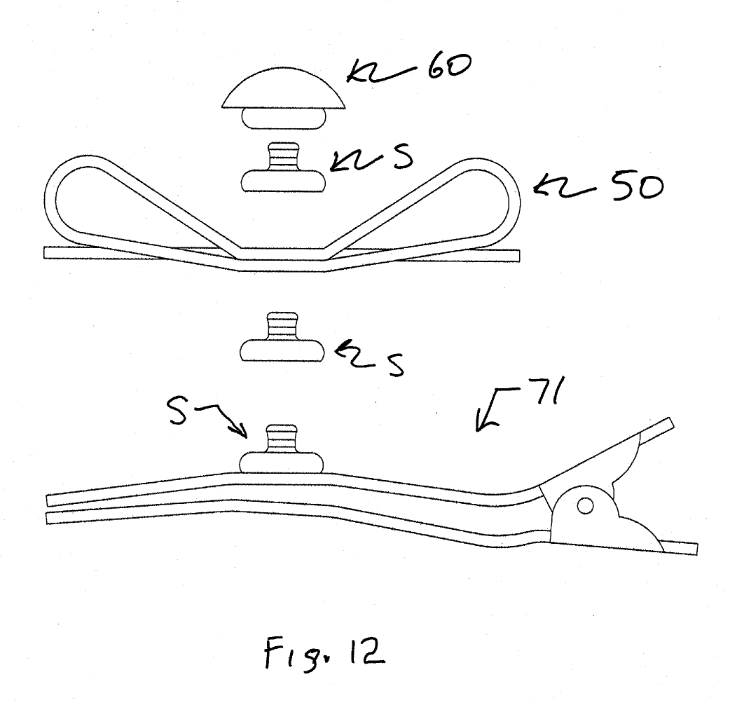

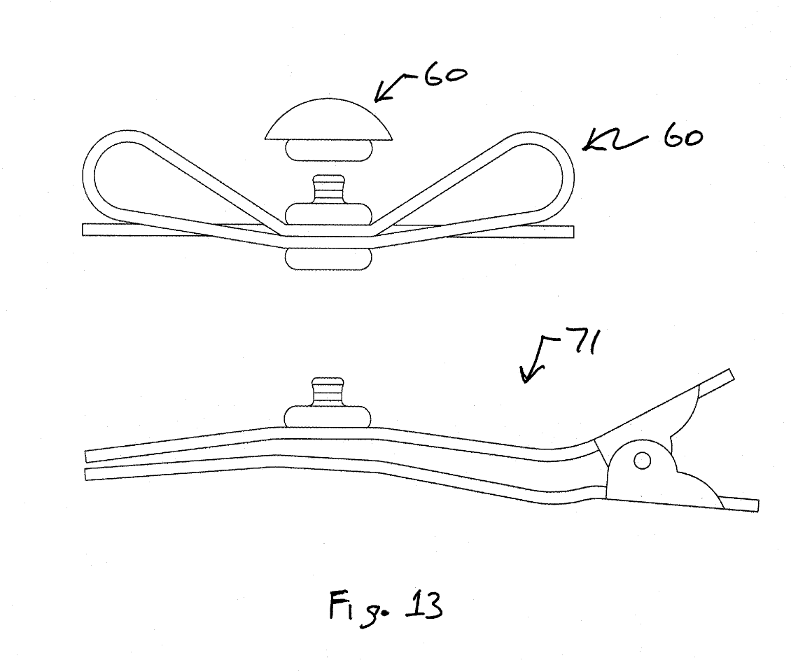

With reference to FIGS. 12-13, it can be seen another exemplary way in which a decorative assembly can be created by a user. In this embodiment, a hair clip 71 is removed from the cover 28. Then, the user begins placing one or more snaps S on the clip 71. Then, one or more decorative elements 50 are placed into alignment with and over the projection of the snap S. Another snap S is then placed over the decorative element so that it is retained between the snaps S. Finally, a decorative element 60 (having a female receiving portion of the snap) is snapped-onto the last snap S. Like the previous embodiment, each snap S has an insertable snap projection and a base portion with the lower snap being affixed (e.g., via adhesive) to the clip 71. The flexible decorative element 50 is thus axially retained and slightly compressed between the snaps S. However, the previous embodiment of FIG. 10, this embodiment has a decorative button 60. As should be apparent, the user has numerous options to make a nearly unlimited variety of the decorative assemblies.

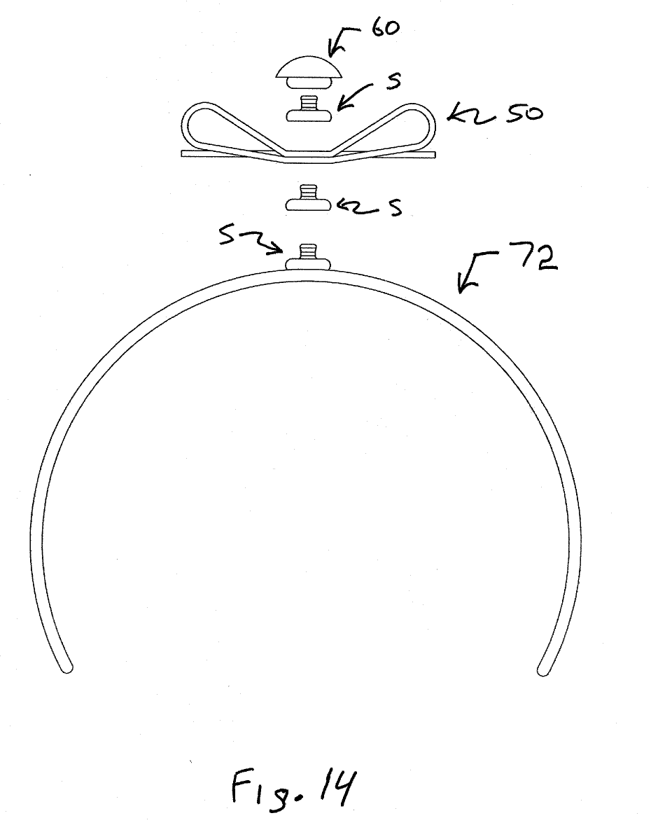

With reference to FIG. 14, it can be seen another exemplary way in which a decorative assembly can be created by a user. In this embodiment, a U-shaped hair band 72 (which can be of any type conventional or otherwise) is removed from one of the boxes in the kit 100 but which already includes a snap S affixed thereto. Then, the user begins placing one or more snaps S on the snap S affixed to the band 72. Then, one or more decorative elements 50 are placed into alignment with and over the projection of the snap S. Another snap S is then placed over the decorative element so that it is retained between the snaps S. Finally, a decorative element 60 (having a female receiving portion of the snap) is snapped-onto the last snap S. Like the previous embodiment, each snap S has an insertable snap projection and a base portion that can receive the projection—with the lower snap being affixed (e.g., via adhesive) to the band 72. The flexible decorative element 50 is thus axially retained and slightly compressed between the snaps S. Moreover, like the previous embodiment, this embodiment has a decorative button 60. As should be apparent, the user has numerous options to make a nearly unlimited variety of the decorative assemblies.

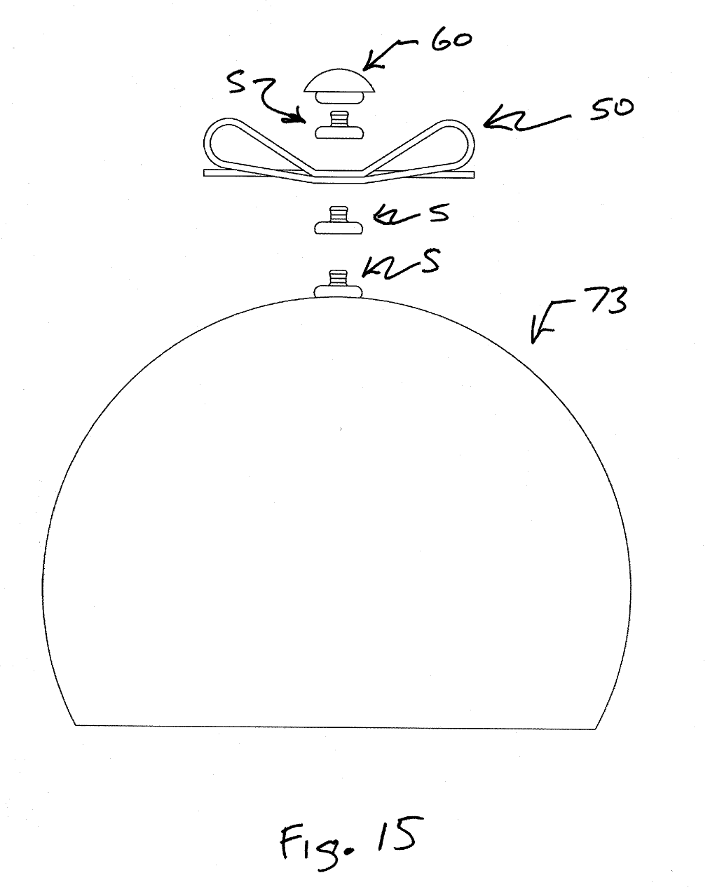

With reference to FIG. 15, it can be seen another exemplary way in which a decorative assembly can be created by a user. In this embodiment, a hat or hood 73 (which can be of any type conventional or otherwise) is removed from one of the boxes in the kit 100 but which already includes a snap S affixed thereto. Then, the user begins placing one or more snaps S on the snap S affixed to the hood 73. Then, one or more decorative elements 50 are placed into alignment with and over the projection of the snap S. Another snap S is then placed over the decorative element so that it is retained between the snaps S. Finally, a decorative element 60 (having a female receiving portion of the snap) is snapped-onto the last snap S. Like the previous embodiment, each snap S has an insertable snap projection and a base portion that can receive the projection—with the lower snap being affixed (e.g., via adhesive) to the hood 73. The flexible decorative element 50 is thus axially retained and slightly compressed between the snaps S. Moreover, like the previous embodiment, this embodiment has a decorative button 60. As should be apparent, the user has numerous options to make a nearly unlimited variety of the decorative assemblies.

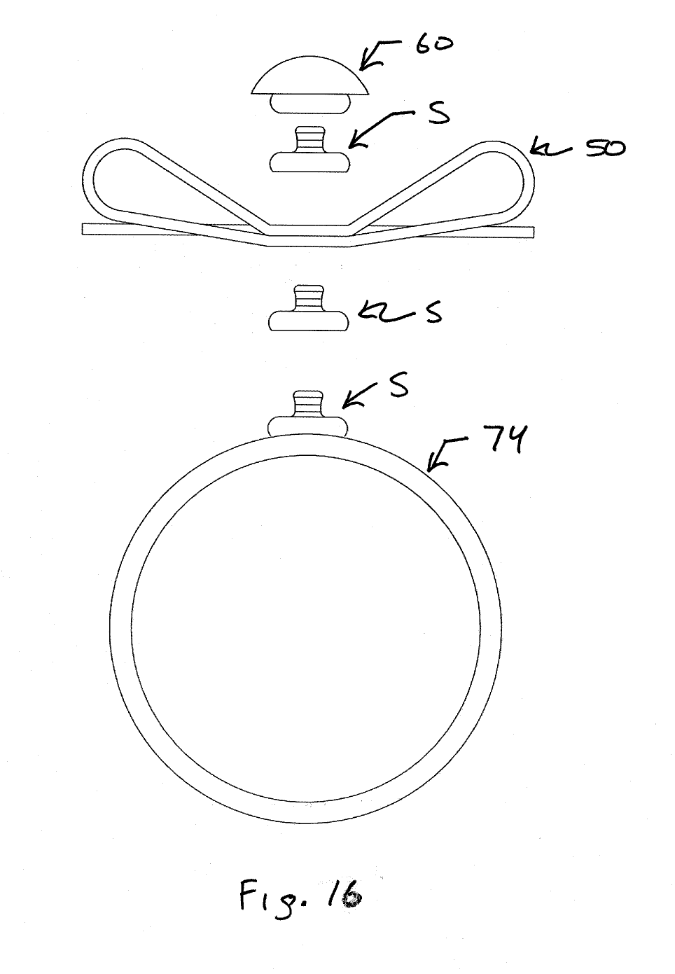

With reference to FIG. 16, it can be seen another exemplary way in which a decorative assembly can be created by a user. In this embodiment, a hair tie 74 (which can be of any type conventional or otherwise) is removed from one of the boxes in the kit 100 but which already includes a snap S affixed thereto. Then, the user begins placing one or more snaps S on the snap S affixed to the tie 74. Then, one or more decorative elements 50 are placed into alignment with and over the projection of the snap S. Another snap S is then placed over the decorative element so that it is retained between the snaps S. Finally, a decorative element 60 (having a female receiving portion of the snap) is snapped-onto the last snap S. Like the previous embodiment, each snap S has an insertable snap projection and a base portion that can receive the projection—with the lower snap being affixed (e.g., via adhesive) to the tie 74. The flexible decorative element 50 is thus axially retained and slightly compressed between the snaps S. Moreover, like the previous embodiment, this embodiment has a decorative button 60. As should be apparent, the user has numerous options to make a nearly unlimited variety of the decorative assemblies.

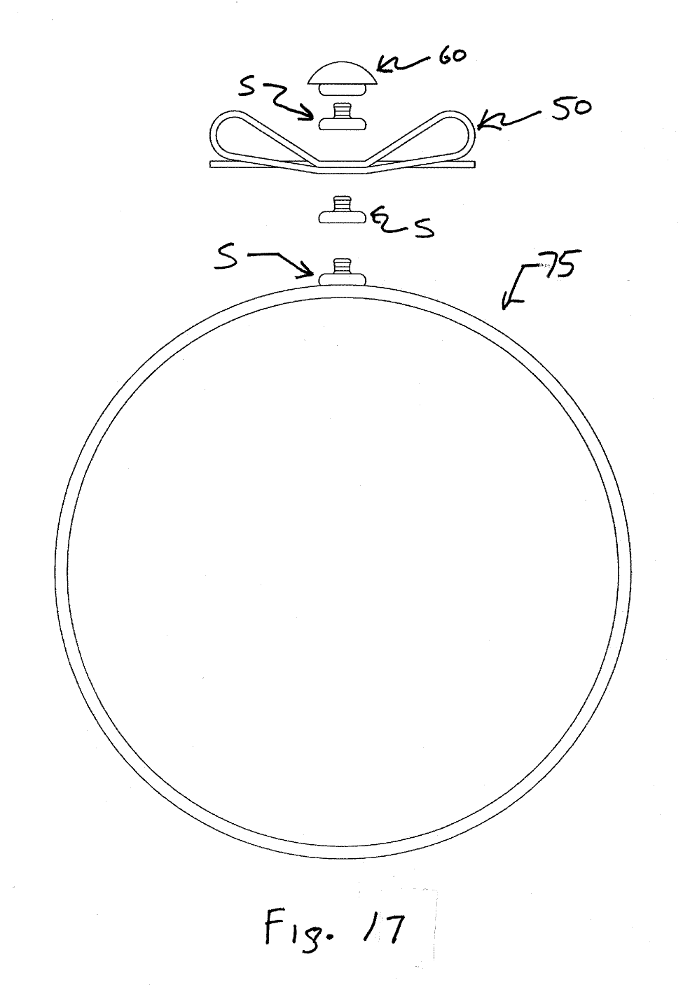

With reference to FIG. 17, it can be seen another exemplary way in which a decorative assembly can be created by a user. In this embodiment, a hair band 74 (which can be of any type conventional or otherwise) is removed from one of the boxes in the kit 100 but which already includes a snap S affixed thereto. Then, the user begins placing one or more snaps S on the snap S affixed to the band 75. Then, one or more decorative elements 50 are placed into alignment with and over the projection of the snap S. Another snap S is then placed over the decorative element so that it is retained between the snaps S. Finally, a decorative element 60 (having a female receiving portion of the snap) is snapped-onto the last snap S. Like the previous embodiment, each snap S has an insertable snap projection and a base portion that can receive the projection—with the lower snap being affixed (e.g., via adhesive) to the band 75. The flexible decorative element 50 is thus axially retained and slightly compressed between the snaps S. Moreover, like the previous embodiment, this embodiment has a decorative button 60. As should be apparent, the user has numerous options to make a nearly unlimited variety of the decorative assemblies.

In an exemplary non-limiting embodiment, the kit of wearable decorative elements 100 comprises at least a main container 10 and at least two securing devices, e.g., snaps S, hook and loop, etc., Each securing device is configured to secure at least one wearable decorative element 50/60 to a user, user's clothing, or to part of a user's body (via e.g., a clip, band 72, hat 73, hair tie 74, and head band 75). At least two wearable decorative elements 50/60 are utilized. In embodiments, the decorative elements resemble flowers or parts thereof.

The devices described herein can also utilize one or more features disclosed in the prior art documents expressly incorporated by reference herein. Furthermore, one or more of the various parts of the non-metal device can preferably be made as one-piece structures by e.g., injection molding, when doing so reduces costs of manufacture. Non-limiting materials for most of the parts include synthetic resins. Although Applicant has shown and described snaps as a preferred connection/attachment mechanism, other connection/attachment mechanisms, whether conventional or otherwise, can be utilized such as hook and loop, etc. The snaps can be of any type and can preferably be made of metal. Furthermore, the invention also contemplates that any or all disclosed features of one embodiment may be used on other disclosed embodiments, to the extent such modifications function for their intended purpose.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

### LIST OF REFERENCE NUMBERS

Kit 100;
Main container or box 10;
Bottom wall of main container or box 11;
Side walls of main container or box 12-15;
Upper edge of main container or box 16;
Inner space of main container or box 17;
First smaller box 20;
Bottom wall of first container or box 21;
Side walls of first container or box 22-25;
Upper edge of first smaller container or box 26;
Inner space of first smaller container or box 27;
Second smaller box 30;
Bottom wall of second container or box 31;
Side walls of second container or box 32-35;
Upper edge of second smaller container or box 36;
Inner space of second smaller container or box 37;
Third smaller box 40;
Bottom wall of third container or box 41;
Side walls of third container or box 42-45;
Upper edge of third smaller container or box 46;
Inner space of third smaller container or box 47;
Decorative element 50;
Pre-assembled decorative element 60;
Securing device with attachment connector or snap 70;
Hair clip 71;
U-shaped head or hair band 72;
Hat 73;
Hair tie 74;
Head or hair band 75;
Cover attachment system 80;
Strap 81;
End attachment section 82;
Decorative element stacking and retaining device 90;
Base 91; and
Pin 92.

What is claimed:

1. A kit of wearable decorative elements comprising:
at least a main container;
at least two securing devices, each securing device being configured to secure at least one wearable decorative element to a user or user's clothing; and
at least two wearable decorative elements.

2. The kit of claim 1, wherein the at least one main container comprises a removable cover or lid.

3. The kit of claim 1, wherein the at least one main container comprises a paper box with a removable cover or lid.

4. The kit of claim 1, further comprising at least one smaller container sized to fit within the main container.

5. The kit of claim 4, wherein the at least one smaller container comprises a paper box with a removable cover or lid.

6. The kit of claim 1, wherein at least one of the at least two securing devices is a hair clip.

7. The kit of claim 1, wherein at least one of the at least two securing devices is a hair tie.

8. The kit of claim 1, wherein the hair tie is at least one of flexible and elastically expandable.

9. The kit of claim 1, wherein at least one of the at least two securing devices is a U-shaped head or hair band.

10. The kit of claim 1, wherein the U-shaped head or hair band is at least one of flexible and elastically expandable.

12. The kit of claim 1, wherein at least one of the at least two wearable decorative elements is at least one of:
a bow;
a hair bow;
a section of an artificial flower section;
an artificial flower;
a button;
a member containing a visible decoration and
a bottle cap.

13. The kit of claim 1, wherein at least one of the at least two wearable decorative elements is at least one of:
non-removably attached to one of the at least two wearable decorative elements; and
non-removably attached to at least one of the at least two securing devices.

14. The kit of claim 1, wherein at least one of the at least two wearable decorative elements is at least one of:
removably attached to one of the at least two wearable decorative elements; and
removably attached to at least one of the at least two securing devices.

15. The kit of claim 1, wherein at least one of the at least two wearable decorative elements comprises a releasable attachment mechanism.

16. The kit of claim 15, wherein the releasable attachment mechanism comprises a snap.

17. A kit for making wearable decorative elements comprising:
at least a main container;
at least two securing devices, each securing device being configured to secure at least one wearable decorative element to a user or user's clothing; and
at least two wearable decorative elements; and
each of the at least two wearable decorative elements comprising a releasable attachment mechanism.

18. The kit of claim 1, wherein at least one of the at least two wearable decorative elements comprises a releasable attachment mechanism.

19. The kit of claim 18, wherein the releasable attachment mechanism comprises a snap.

20. A method of making at least one wearable decorative element utilizing a kit comprising at least a main container, at least two securing devices, each securing device being configured to secure at least one wearable decorative element to a user or user's clothing; and at least two wearable decorative elements, the method comprising:
at least one of:
attaching at least one decorative element to at least one securing device;
mounting at least one decorative element to at least one securing device;
removably securing at least one decorative element to at least one securing device; and
securing at least one decorative element to at least one securing device using a snap; and
securing the at least one securing device to a user or a user's clothing.
